(19) United States
(12) Patent Application Publication
(10) Pub. No.: US 2016/0049027 A1
(43) Pub. Date: Feb. 18, 2016

(54) ELECTRONIC LOCK WITH SELECTABLE POWER SOURCES

(71) Applicant: UTC FIRE AND SECURITY AMERICAS CORPORATION, INC., Bradenton, FL (US)

(72) Inventors: Nicholas Charles Soldner, Southbury, CT (US); Ritesh Khire, Manchester, CT (US); Alan Marchiori, Glastonbury, CT (US); Vijaya Ramaraju Lakamraju, Longmeadow, MA (US); Adam Kuenzi, Silverton, OR (US); Wayne Larson, Salem, OR (US); Joseph Zacchio, Wethersfield, CT (US)

(21) Appl. No.: 14/778,890

(22) PCT Filed: Mar. 12, 2014
(86) PCT No.: PCT/US2014/023880

§ 371 Date: Sep. 21, 2015

Related U.S. Application Data
(60) Provisional application No. 61/804,432, filed on Mar. 22, 2013.

(51) Int. Cl. G07C 9/00; H04W 4/00

(52) U.S. Cl. CPC G07C 9/00007; H04W 4/008; G07C 2009/00634; G07C 2009/00769

(57) ABSTRACT

Embodiments are directed to determining, by a processing device, a state of an internal power supply associated with a lock, and selecting, by the processing device, at least one of the internal power supply and an external power supply to power the lock based on the determination of the state of the internal power supply.

### BACKGROUND

Mechanical removable lock cores are prevalent in use. The small format interchangeable core (SFIC) is an example of such a mechanical removable lock core. Lock cores may be used in a number of applications, such as doors, cabinets, and other entities or devices that have an ability to accept a mechanical removable lock core. Traditional lock cores use a first key for standard operation by users and a second key for operation by, e.g., facility security managers. The second key may be used to remove the lock core.

Some lock cores utilize an electromechanical actuator within the core that is operable through the use of an electronic key. Use of an electromechanical core and electronic key provides for convenience in terms of allowing a reprogramming of user access remotely (e.g., rekeying) without a need to physically remove a core. However, a user is still required to carry a key. Keys are subject to being lost or broken, which may further represent a security risk and/or administrative inconvenience to replace a key.

### BRIEF SUMMARY

An embodiment of the disclosure is directed to a method comprising: determining, by a processing device, a state of an internal power supply associated with a lock, and selecting, by the processing device, at least one of the internal power supply and an external power supply to power the lock based on the determination of the state of the internal power supply.

An embodiment of the disclosure is directed to a lock core comprising: an energy storage element, a harvester configured to wirelessly harvest energy from a source located external from the lock core, an actuator configured to control a state of a lock associated with the lock core, a storage device configured to selectively receive energy from the energy storage element and the harvester and provide energy to the actuator, and a processing device configured to select whether the storage device receives energy from the energy storage element or the harvester to provide the energy to the actuator.

An embodiment of the disclosure is directed to a lock core comprising: a power circuit configured to be powered directly from a mobile key, wherein the power circuit does not include an internal primary battery storage.

Additional embodiments are described below.

### BRIEF DESCRIPTION OF THE DRAWINGS

The present disclosure is illustrated by way of example and not limited in the accompanying figures in which like reference numerals indicate similar elements.

FIG. 1 is a schematic block diagram illustrating an exemplary computing system in accordance with one or more embodiments;

FIG. 2 illustrates an exemplary circuit in accordance with one or more embodiments; and

FIG. 3 illustrates a flow chart of an exemplary method in accordance with one or more embodiments.

### DETAILED DESCRIPTION

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

Exemplary embodiments of apparatuses, systems, and methods are described for improving a user experience with lock cores by removing a need for a physical key, such as a mechanical or electronic key. In some embodiments, a lock core may be self-powered, and a state of the lock (e.g., locked or unlocked) may be determined based on a wireless communication. For example, a user may operate the lock core based on a device that the user normally has in her possession, such as a mobile phone. The lock may include an internal power source for normal operations, as well as a rechargeable storage element which may allow the lock to be powered from one or more external sources (e.g., external wireless sources). Powering the lock from an external source may be used for management or emergency purposes, or may be performed to remove the lock. Aspects of the disclosure may be applied in connection with an electromechanical replaceable lock core, a standard electronic lock, etc.

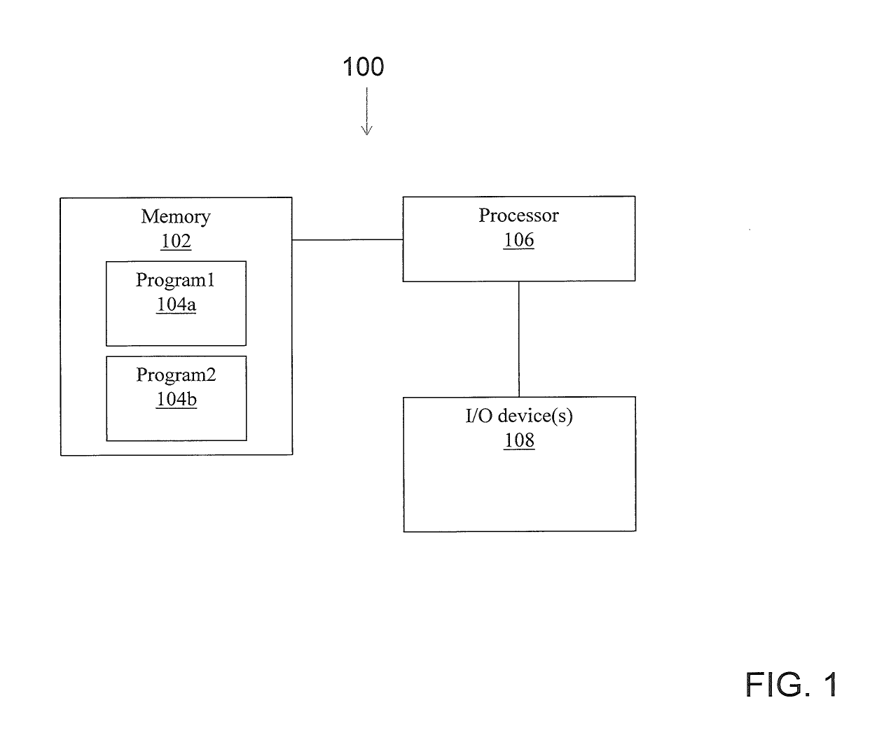

Referring to FIG. 1, an exemplary computing system 100 is shown. The system 100 is shown as including a memory 102. The memory 102 may store executable instructions. The executable instructions may be stored or organized in any manner and at any level of abstraction, such as in connection with one or more processes, routines, procedures, methods, etc. As an example, at least a portion of the instructions are shown in FIG. 1 as being associated with a first program 104a and a second program 104b.

The instructions stored in the memory 102 may be executed by one or more processors, such as a processor 106. The processor 106 may be coupled to one or more input/output (I/O) devices 108. In some embodiments, the I/O device(s) 108 may include one or more of a keyboard or keypad, a touchscreen or touch panel, a display screen, a microphone, a speaker, a mouse, a button, a remote control, a joystick, a printer, a telephone or mobile device (e.g., a smartphone), etc. The I/O device(s) 108 may be configured to provide an interface to allow a user to interact with the system 100.

The system 100 is illustrative. In some embodiments, one or more of the entities may be optional. In some embodiments, additional entities not shown may be included. For example, in some embodiments the system 100 may be associated with one or more networks. In some embodiments, the entities may be arranged or organized in a manner different from what is shown in FIG. 1. One or more of the entities shown in FIG. 1 may be associated with one or more of the devices or entities described herein.

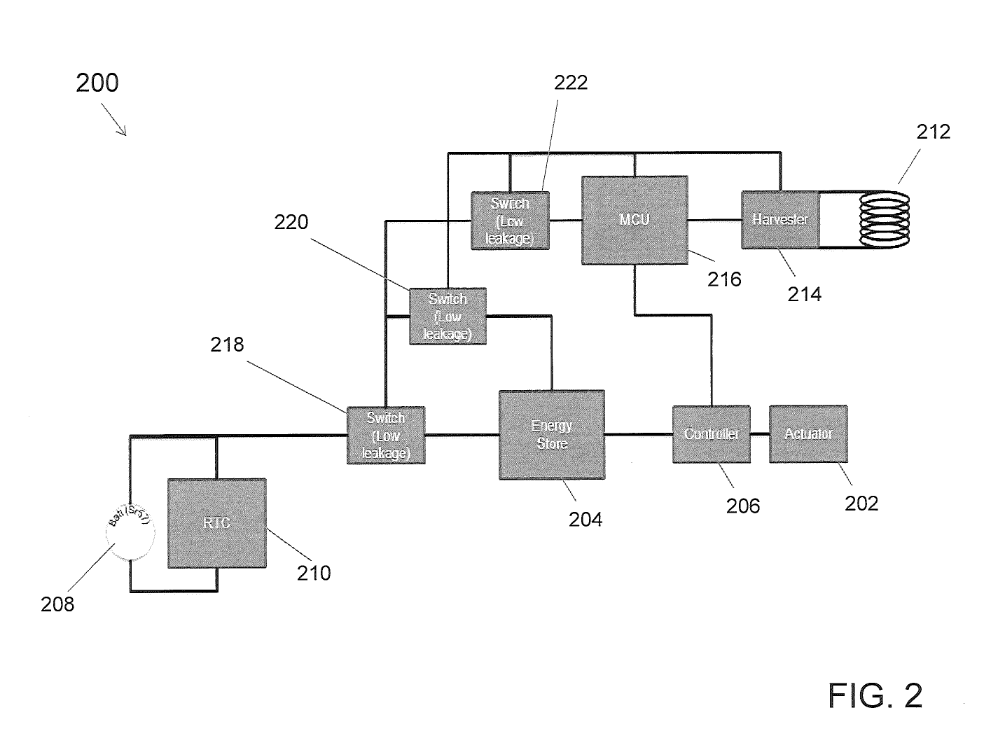

FIG. 2 illustrates an exemplary circuit architecture 200. As described further below, the circuit 200 may be used to selectively power a lock or lock core using an internal power source or an external power source. In some embodiments, the external power source may include a wireless power source, such as power that may be harvested from a wireless device (e.g., a mobile phone or administrative tool provided with the system). In some embodiments, the external power source may include a thermal source or a light source.

The circuit 200 may include an actuator 202. The actuator 202 may correspond to an electromechanical device. The actuator 202 may receive power or energy from an energy store 204 by way of a controller 206. The actuator 202 may be responsible for controlling a state (e.g., locked or unlocked) of a lock. The actuator 202 may include a motor or motor drive components. The controller 206 may ensure that the actuator 202 is placed in an appropriate state or position.

The energy store 204 may directly power the controller 206 and actuator 202. The energy store 204 may be driven by an internal power source or an external power source. The energy store 204 may include one or more super-capacitors or capacitors featuring relatively minimal resistance. Alternatively, the energy store 204 may include lower quality or higher-resistance capacitors. A design decision may be made regarding a capacity or responsiveness of the energy store 204 relative to a size or type of the components used. For example, smaller components (e.g., capacitors) may be used in embodiments where a lock core is implemented using a small form factor, which may tend to increase response times. Conversely, larger components (e.g., capacitors) may be used in embodiments where fast response times at needed, potentially at the expense/cost of an increased form factor for the lock core. Components may be selected or sized in order to reduce or minimize power draw or power consumption. For example, components may be selected to provide for a small idle or sleep current. For example, a sleep current of approximately 200 nA-3 uA may be provided, or a sleep current within an order of magnitude of 1 uA.

The internal power source may include a primary energy storage element. For example, the primary energy storage element may include a battery 208. In addition to providing power or energy to the energy store 204, the battery 208 may power a real-time clock (RTC) 210. The RTC 210 may be used for data logging purposes or may be used to determine when a particular user should be able to change the state of the lock. The RTC 210 may be implemented using the MCU 216 to reduce the space required by the circuit 200.

The external power source, which may be illustratively represented by a (coupling) coil 212 in FIG. 2, may be associated with an external device, such as a wireless device that a user typically has in her possession. Such a wireless device may include a mobile phone (e.g., a smartphone). Power provided by the wireless device 212 may be obtained by a harvester 214 for potential use or collection by the energy store 204. Power transfer may also be enabled through use of propagating waves using either a coil or standard antenna as a physical interface.

The circuit 200 may include a processing device, such as a PIC or MSP-class device, a digital signal processor, or microcontroller unit (MCU) 216. In some embodiments, the MCU 216 may correspond to the processor 106 and/or the memory 102 of FIG. 1. The MCU 216 may determine which power source (e.g., internal power or external power) should be used by the energy store 204 to power and control the controller 206 and/or the actuator 202. The MCU 216 may also be used to control the actuator 202 through analog or digital ports.

In some embodiments, the MCU 216 may select the harvester 214 to provide energy to the actuator 202 when the primary energy storage element (e.g., the battery 208) provides energy in an amount less than a threshold or is depleted. In some instances, temperature may dictate selection of the harvester 214. For example, when it is cold outside, the battery 208 might not be able to provide sufficient energy. Energy provided to the actuator 202 by the harvester 214 may be used to remove a lock core so that the battery 208 can be replaced.

The circuit 200 may include one or more switches, such as switches 218, 220, and 222. The switch 218 may be used to selectively provide power from the internal power source or battery 208 to the energy store 204. The switch 220 may be used to selectively provide power from the external power source 212, via the harvester 214, to the energy store 204. The switch 222 may be used to selectively power the MCU 216 from the external power source 212 via the harvester 214, which may be used, for example, when the battery 208 is depleted.

The circuit 200 is illustrative. In some embodiments, one or more of the entities may be optional (e.g., RTC 210). In some embodiments, additional entities not shown may be included. For example, in some embodiments the circuit may include a transceiver (e.g., a wireless transceiver) that may be configured to engage in one or more communications (e.g., one or more encrypted communications) with one or more devices (e.g., a mobile device or phone). In some embodiments, the entities may be arranged or organized in a manner different from what is shown in FIG. 2.

As described above, the operation of a lock may be controlled via a user's mobile device. Thus, the user might not have to carry a separate mechanical or electronic key specifically devoted to operating the lock. The lock core may be a standalone unit that may be self-powered, with an ability to harvest energy from an external source. The external source may be the user's mobile device. The harvesting may occur using one or more techniques or schemes. For example, the harvesting may be based on a near field communication (NFC) or operate at standard ISM frequencies (e.g. 900 MHz, 2.4 GHz etc.). The harvesting may allow the lock core to be removed, potentially in connection with an emergency.

In some embodiments, the lock core may maintain a data log or trail. The data may be accessed or viewed by a device or location that is remote from the lock core. More generally, the lock core may engage in communications (e.g., encrypted communications) with one or more devices or entities.

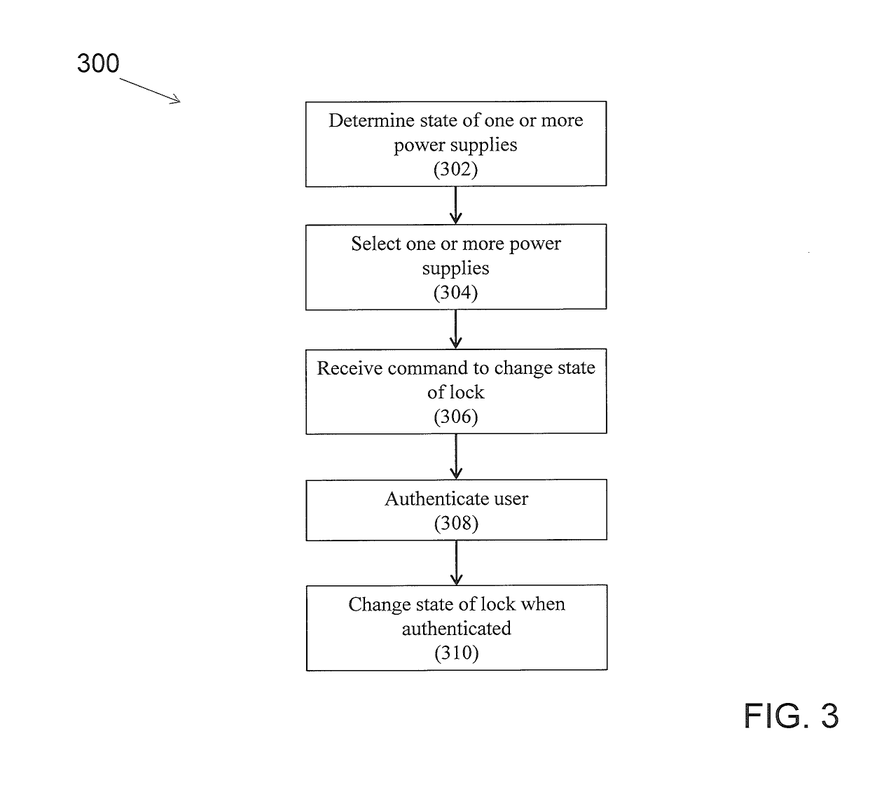

Turning now to FIG. 3, a flow chart of an exemplary method 300 is shown. The method 300 may be executed by one or more systems, circuits, devices, or components, such as those described herein. The method 300 may be used to power an actuator (e.g., actuator 202 of FIG. 2) that may be used to select a state for a lock, wherein the power may be derived from an internal power source or an external power source.

In block 302, a determination may be made regarding a state of one or more power supplies. For example, a determination may be made whether power provided by an internal power supply is available in an amount greater than a threshold or in an amount that is greater than an external power supply.

In block 304, one or more power supplies to use may be selected. For example, if the determination of block 302 indicates that the internal power supply is capable of providing power in the amount greater than the threshold then the internal power supply may be used. Otherwise, an external power supply may be used if such external power supply is available. External power may be harvested from a device associated with a user, such as a mobile device or a phone. In some embodiments, external power may be harvested based on mechanical energy (e.g., a push to charge type of lock).

In block 306, a command may be received to change a state of the lock. For example, if the lock is in a locked state, the command of block 306 may direct the lock to unlock. The command may be received from a device associated with a user, such as a mobile device or a phone. The command may include one or more credentials or identifiers that may indicate whether the user has been provided access rights to control or change the state of the lock.

In block 308, the user may be authenticated. For example, if the command of block 306 includes one or more credentials, the one or more credentials may be compared to a listing of authorized users to determine whether the command should allow the state of the lock to change.

If the user is authenticated in block 308, then the lock may change state in block 310. As part of block 310, an entry in a data log may be generated. The entry may specify one or more of the date and time that the command for changing the state of the lock was received, whether the state of the lock was changed, the state that the lock was changed from or to, and an identity of the user or a device associated with the user.

The method 300 is illustrative. In some embodiments, one or more of the blocks or operations (or portions thereof) may be optional. In some embodiments, additional operations not shown may be included. In some embodiments, the operations may execute in an order or sequence different from what is shown.

In some embodiments, access to a lock or lock core may be a function of an amount of energy provided by a primary energy storage element (e.g., a battery) and a level associated with a user attempting to access the lock/lock core. For example, if an amount of energy provided by the primary energy storage element is less than a threshold, a general user might be precluded access, such that only “supervisory-level” users can use the battery for normal operation down to a certain battery level or certain number of operations, followed by certain authorized keys being able to open and/or remove the lock using, e.g., inductive coupling.

Embodiments of the disclosure may be tied to one or more particular machines. For example, one or more devices, apparatuses, systems, or architectures may be configured to power a lock core or actuator using an internal power source (e.g., a battery) or an external power source (e.g., power harvested from a device associated with a user).

Embodiments of the disclosure may provide for a flexible architecture that allows a seamless power transfer from an internal power source to an external power source (and vice versa). In some embodiments, an electromechanical replaceable lock core may include a circuit to facilitate such power transfer. Regardless of which power source is used, the same level of security or authentication may be adhered to, resulting in no loss of functionality.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments may be implemented using one or more technologies. In some embodiments, an apparatus or system may include one or more processors, and memory storing instructions that, when executed by the one or more processors, cause the apparatus or system to perform one or more methodological acts as described herein. Various mechanical components known to those of skill in the art may be used in some embodiments.

Embodiments may be implemented as one or more apparatuses, systems, and/or methods. In some embodiments, instructions may be stored on one or more computer-readable media, such as a transitory and/or non-transitory computer-readable medium. The instructions, when executed, may cause an entity (e.g., an apparatus or system) to perform one or more methodological acts as described herein.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

1. A method comprising:
determining, by a processing device, a state of an internal power supply associated with a lock; and
selecting, by the processing device, at least one of the internal power supply and an external power supply to power the lock based on the determination of the state of the internal power supply.

2. The method of claim 1, further comprising:
harvesting energy from a device associated with the external power supply.

3. The method of claim 2, wherein the device associated with external power supply comprises a mobile phone, the method further comprising:
receiving a command from the mobile phone to change a state of the lock.

4. The method of claim 3, wherein the command comprises at least one credential, the method further comprising:
changing the state of the lock based on an authentication of the at least one credential.

5. The method of claim 3, wherein the energy is wirelessly harvested from the mobile phone and the command is received from the mobile phone using a near field communication (NFC).

6. The method of claim 3, further comprising:
generating an entry in a data log based on the command.

7. The method of claim 6, wherein the entry specifies one or more of: (i) the date and time that the command was received, (ii) whether the state of the lock was changed in response to the command, (iii) the state that the lock was changed from when the state of the lock is changed, (iv) the state that the lock was changed to when the state of the lock is changed, (v) an identity of the mobile phone, and (vi) an identity of a user associated with the mobile phone.

8. The method of claim 1, wherein the lock comprises at least one of an electromechanical replaceable lock core and a standard electronic lock.

9. The method of claim 1, further comprising:
selecting, by the processing device, the internal power supply to power the lock when the determination of the state of the internal power supply indicates that the internal power supply provides power in an amount greater than a threshold and otherwise selecting the external power supply to power the lock.

10. A lock core comprising:
an energy storage element;
a harvester configured to harvest energy from a source located external from the lock core;
an actuator configured to control a state of a lock associated with the lock core;
a storage device configured to selectively receive energy from the energy storage element and the harvester and provide energy to the actuator; and
a processing device configured to select whether the storage device receives energy from the energy storage element or the harvester to provide the energy to the actuator.

11. The lock core of claim 10, wherein the processing device comprises at least one of a PIC, an MSP-class device, a digital signal processor, and a microcontroller unit (MCU).

12. The lock core of claim 10, wherein the source located external from the lock core comprises a mobile phone.

13. The lock core of claim 12, further comprising:
a transceiver configured to receive a command from the mobile phone to change a state of the lock.

14. The lock core of claim 13, wherein the command comprises at least one credential, and wherein the lock core is configured to change a state of the lock based on an authentication of the at least one credential.

15. The lock core of claim 10, further comprising:
a first switch configured to selectively provide energy from the energy storage element to the storage device; and
a second switch configured to selectively provide energy from the harvester to the storage device.

16. The lock core of claim 15, further comprising:
a third switch configured to selectively provide energy from the harvester to the processing device.

17. The lock core of claim 10, wherein the storage device comprises a super-capacitor.

18. The lock core of claim 10, wherein a sleep current associated with the lock core is within an order of magnitude of one microampere.

19. The lock core of claim 10, wherein the energy storage element comprises a battery.

20. The lock core of claim 19, wherein the processing device is configured to select the harvester to provide the energy to the actuator when the battery provides energy in an amount less than a threshold, and wherein the energy provided to the actuator by the harvester is used to remove the core so that the battery can be replaced.

21. The lock core of claim 19, wherein access to the lock core is a function of an amount of energy provided by the battery and a level associated with a user attempting to access the lock core.

22. A lock core comprising:
a power circuit configured to be powered directly from a mobile key,
wherein the power circuit does not include an internal primary battery storage.

23. The lock core of claim 22, wherein the mobile key comprises a phone.
